(19) United States
(12) Patent Application Publication
(10) Pub. No.: US 2008/0013823 A1
(43) Pub. Date: Jan. 17, 2008

(54) Overhead traveling camera inspection system

(76) Inventors: Merlin E. Behnke, Mequon, WI (US); Rob G. Bertz, Wauwatosa, WI (US); Duane B. Jahnke, Hartford, WI (US); Ken J. Pikus, New Berlin, WI (US); Dave J. Rollmann, New Berlin, WI (US); Mark R. Shires, Glendale, WI (US); Mike J. Reilly, Mukwonago, WI (US); Todd K. Pichler, New Berlin, WI (US)

Correspondence Address: Mark Shires;International Product Tech., 3100 S. 166th St., New Berlin, WI, 53151, US

(21) Appl. No.: 11/823,740

(22) Filed: Jun. 28, 2007

Related U.S. Application Data
(60) Provisional application No. 60/818,050, filed on Jun. 30, 2006.

(51) Int. Cl. G06K 9/00

(52) U.S. Cl. 382/145

(57) ABSTRACT

An overhead traveling camera inspection system for inspecting the condition of electronic semiconductor devices after being handled by a pick and place mechanism, and for automatically determining and calibrating the precise location of modules serviced by the pick and place mechanism for more accurate picking and placing of semiconductor devices.

### CROSS REFERENCE TO RELATED APPLICATIONS

This application claims the benefit of provisional patent application Ser. No. 60/818,050 filed Jun. 30, 2006 by the present inventors.

### FEDERALLY SPONSORED RESEARCH

Not Applicable.

### SEQUENCE LISTING OR PROGRAM

Not Applicable.

### BACKGROUND

1. Field of the Invention

The present invention relates generally to machine vision inspection and more specifically it relates to an overhead traveling camera inspection system for inspecting the condition of electronic semiconductor devices after being handled by a pick and place mechanism, and for automatically determining and calibrating the precise location of modules serviced by the pick and place mechanism for more accurate picking and placing of semiconductor devices.

2. Prior Art

It can be appreciated that machine vision inspection after placement of electronic devices has been in use for years. Typically, inspection after placement systems are comprised of a moving inspection system that inspects devices in a single output medium module such as a tray stacker or transfer module. Inspecting devices after they have been handled by a pick and place is common to verify that the device has been placed in the desired destination, and that the device has not been damaged during handling.

U.S. Pat. No. 5,237,622 to Howell (1993) discloses a camera-based method of detecting pick and place placement error, but it only samples the process after placement for subsequent corrective action. It does not proactively determine the desired placement location, nor verify final placement accuracy.

U.S. Pat. No. 7,085,622 to Sadighi (2006) describes a traveling, robotically positioned camera used to set up a robot's service coordinates and the distances between these by imaging a reference calibration target. However, it does not operate real-time during production to verify placement location.

U.S. Pat. No. 4,980,971 shows a two camera system, one on a robot and one stationary to view a semiconductor device on the robot arm which, by coordinating camera information, can accurately place devices. This invention, however, requires two cameras, and does not inspect for damage after the device is placed.

One shortcoming with conventional inspection after placement systems is that none of these products have a camera that can travel the length of the pick and place stroke to inspect devices placed into different modules. Additionally, none of the prior art have a camera that can travel the length of the pick and place stroke to calibrate the location of modules on the machine, and therefore machine calibration is an error prone and tediously manual process. Finally, none of the prior art have a camera that can calibrate nozzle locations relative to module locations.

### SUMMARY OF THE INVENTION

The present invention generally consists of a camera, lens and horizontal transporting means that can move the camera and lens across a semiconductor processing machine, in order to perform machine vision inspection and measurement.

The primary object of the present invention is to provide an overhead traveling camera inspection system for inspecting the condition of electronic semiconductor devices after being handled by a pick and place mechanism, regardless of their output location. Additionally, the system can move quickly and automatically in real-time during a production run to inspect electronic devices in multiple locations after they are placed in trays or tape by a pick and place mechanism. A third object of the invention is to determine the exact location of the other modules on the machine in order to calibrate the machine during a set up time. This information is then used to more precisely guide the pick and place movements. The other modules can include input tray modules, output tray modules, taper modules, vision inspection modules, electrical test modules, the pick and place heads or nozzles and other modules that may be on the machine. A final object is to calibrate the pick and place nozzles relative to other modules on the machine.

Note that the use of the term “overhead” is not meant to imply that the camera must be above a person's head, but rather that the camera is above the modules serviced by the pick and place.

### BRIEF DESCRIPTION OF THE DRAWINGS

FIG. 1 is an isometric view of the invention.

FIG. 2 is an isometric view of the invention positioned above modules on a machine.

FIG. 3 is a side view of FIG. 2.

### DETAILED DESCRIPTION OF THE INVENTION

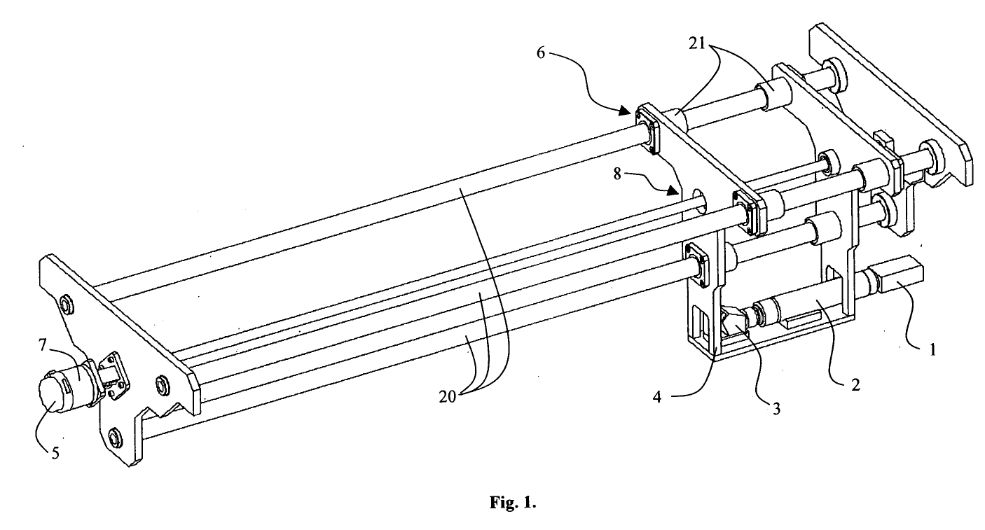

The attached figures illustrate an overhead traveling camera inspection system, which comprises a camera 1, a lens 2, a prism 3, a carriage 4, a positional encoder 5, a linear bearing 6, and a linear actuator comprising a servomotor 7 and a screw drive 8. These are depicted in FIG. 1.

The camera 1 is an electronic CCD camera commonly used for machine vision. The camera can be any of a variety of electronic CCD cameras including the Sony XC-ST30 or the Basler A202k. A variety of CCD cameras can be used.

The lens 2 is a typical optical machine vision lens. It can be a zoom lens.

The prism 3 is a pentaprism used to fold the optical path by 90 degrees so that the camera looks downward. This allows for a compact and rigid design. In another embodiment the prism is not needed because the camera is already oriented looking downward.

The carriage 4 is a structural member that can move horizontally. The carriage rigidly supports a camera 1, lens 2 and prism 3 and couples to the linear bearing 6 and screw drive 8. The carriage could be made out of a variety of materials and have a variety of shapes.

The positional encoder 5 is a rotary encoder that connects to the rotating shaft of the servomotor 7 to report the angular position of the shaft. The positional encoder consists of a stationary read head and a disk shaped rule attached to the shaft. The rule contains indicator marks at highly accurate intervals. The read head optically senses the indicator marks as the shaft rotates and electronically reports the consequent positional location of the carriage. Absolute and relative encoders can be used. Alternatively a linear encoder could be placed along the linear bearing. Laser and other positional sensors could be used.

The linear bearing 6 consists of three stationary rods 20 and allows the carriage to move horizontally via six bushings 21 connected to the carriage. The linear bearing is about 2 meters long and allows for smooth movement in a horizontal direction. The linear bearing supports the weight of the carriage. A variety of linear bearings and lengths would-work.

The linear actuator comprises an electric servomotor 7 that turns a screw drive 8 to move the carriage. As the screw turns it moves a coupling connected to the carriage and hence moves the carriage. The linear actuator could alternatively utilize a linear motor, a belt drive, a chain drive or other possibilities.

The camera is connected to the lens. The pentaprism is located in front of the lens to deviate the line-of-sight by 90 degrees. This makes the camera mounting convenient, compact and rigid. The lens is attached to the carriage. Bushings are attached to the carriage. The linear bearing consists of three rods which pass thru the bushings in the carriage. The rods are attached to a stationary frame. A screw drive nut is also attached to the carriage. The drive screw passes through the nut so that when the drive screw rotates, the nut moves horizontally and thus propels the carriage. The servomotor is attached to the frame. The shaft of the servomotor is attached to the drive screw. The shaft of the servomotor is also attached to the positional encoder. Various means of propulsion could be used to move the camera. Various linear bearings are possible.

An electronic controller such as a computer activates the linear actuator to move the carriage so the camera line-of-sight is above the pick and place output destination. The camera inspects the device after it is placed in its destination. If the camera is above a tray and the device passes, then the camera is moved to the next area of the tray to be inspected. If the device fails, then the carriage waits as the pick and place removes the bad device and puts another device in its place. The inspection and replacement sequence is repeated until a device passes. If the output destination is tape, then the carriage moves so that the camera can image a device just slightly downstream of the placement location. After the image(s) are taken, the tape can index forward. If the device passes inspection, then operation proceeds as normal. If the device fails, then the pick and place replaces the device and the carriage moves the camera to the location of the replaced device and inspects the device. If the device fails, then the replacement and inspection repeats. If the device passes, then the carriage may move back to its previous location for inspection.

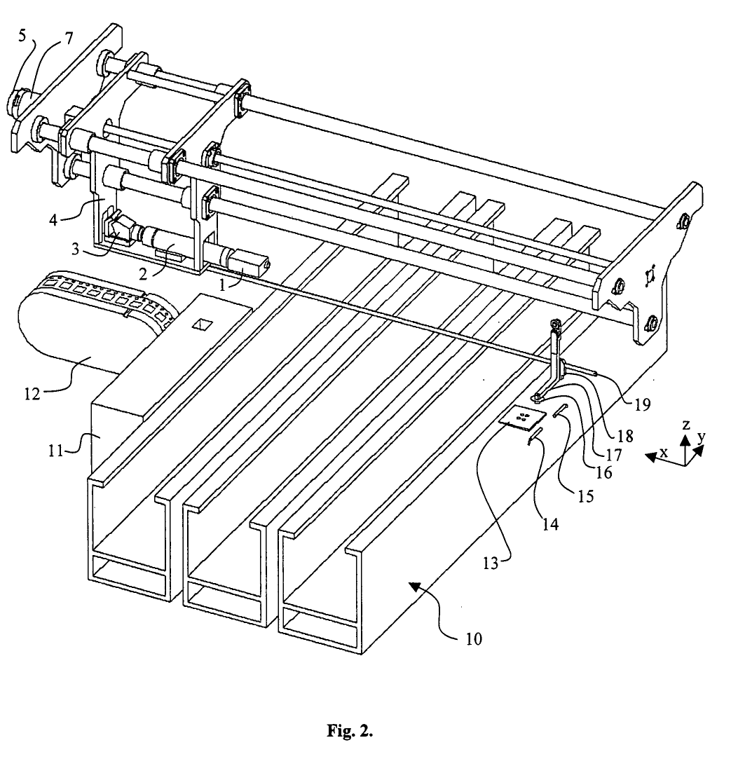

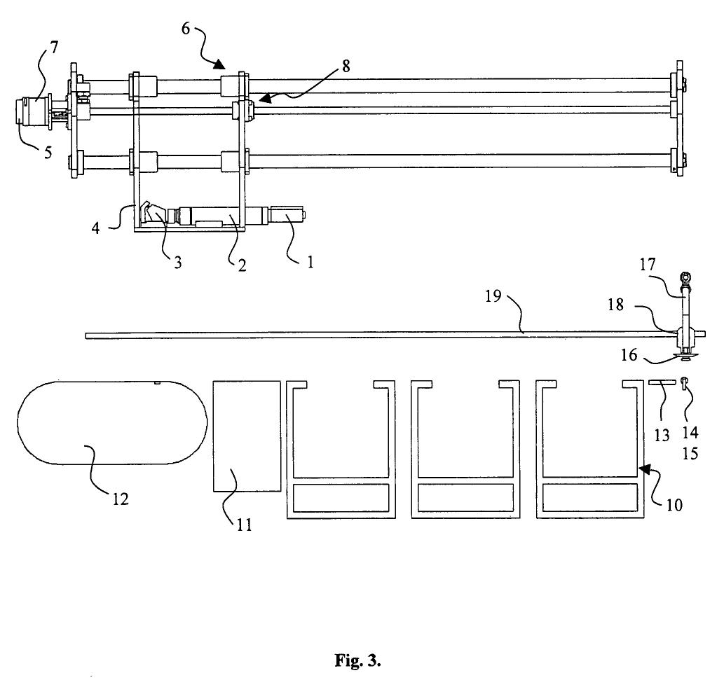

FIGS. 2 and 3 depict the invention positioned above modules as it would be on a machine. A vacuum pick and place nozzle 16 can travel along the same axis as the traveling camera 1. The nozzle can pick devices out of trays in one of the tray stacker modules 10 and place them into a tray in another tray stacker module or into tape in a taper module 12. In this embodiment the taper is oriented along the same axis as the pick and place (and traveling camera) so that multiple pockets in the taper are accessible to the pick and place nozzle and to the camera. The pick and place can also present the device to a vision system 11 or electrical tester.

Calibrating the machine can be accomplished as follows. The carriage 4 first moves the camera 1 to a calibration target 13. The camera then calibrates its pixel size and orientation. Machine vision software identifies the predetermined feature in the center of the target and determines its x location in the image (x₁). The current output of the positional encoder is noted (x_{CameraEncoder1}), and the x location of the target center feature relative to the encoder is computed as x_{CameraDatum}=(x_{CameraEncoder1})+(x₁). Next the carriage moves the camera to a predetermined feature on a tray stacker 10. Using the positional encoder 6 the machine knows roughly where to move the carriage to find this feature. The feature can be simply the edge of a rail on the tray stacker or a drilled hole or some other feature. It could also be a first pocket in the tray. The camera 1 then takes a picture and machine vision software identifies the feature and determines its x location in the image (x₂). This location information is coupled with the current positional encoder information (x_{CameraEncoder 2}) to map the module's location relative to calibration target 13 as xTrayModule1=(x_{CameraEncoder 2})+(x₂)−x_{CameraDatum}. The carriage is then moved to the other tray stackers to determine their location in the same fashion. The location of all of the machine modules, such as a vision system 11, electrical tester, a taper module 12, and any other modules can be determined in the same way.

Additionally each pick and place nozzle can be calibrated relative to the overhead camera positional encoder. Pick and place nozzle 16 is supported by arm 17 which is attached to encoder 18 which reads rule marks on stationary rule 19. The camera or nozzle can be moved so that the nozzle is in the camera's field of view. A feature on the top of the nozzle can be identified and the location in the image measured (x₃). The current camera encoder value is noted (x_{CameraEncoder3}). The current nozzle location relative to the calibration target can be calculated as follows:

x_{CalibrationNozzleLocation}=x_{CameraEncoder3}+x₃×x_{CameraDatum}

The nozzle has its own encoder that is parallel to the camera movement. If the current reading on the nozzle encoder is Ψ₁ then at any future time we can determine the nozzle's offset from the calibration target as:

Nozzle current X location=Ψ₁−x_{CalibrationNozzleLocation}.

We can also know the location of any module relative to the nozzle's encoder. Viewing the nozzle's location from the traveling camera may not be ideal, as the feature on the top of the nozzle might not accurately represent the center of the nozzle, or the traveling camera's optical axis may not be coincident with the vertical stroke of the nozzle, or the nozzle may be out of focus because it is on a different plane than the modules. Thus, another method to correlate the nozzle's location is to employ a stationary through beam optical sensor. Emitter 14 is positioned opposite receiver 15 and in the same plane as the other modules. The camera is moved over the sensor location and measures the sensor location in the image (x₄). The sensor barrel location may be determined or another feature that correlates to the sensor's location. This location information is coupled with the current positional encoder information (x_{CameraEncoder 4}) to map the sensor's location relative to calibration target 13 as:

xSensor=(x_{CameraEncoder 4})+x₄−x_{CameraDatum}.

Next, nozzle 16 can be moved thru the beam and trigger the sensor. As the nozzle moves, the nozzle encoder values are noted when the beam is interrupted and then restored. Averaging these values provides the center value for the nozzle (Ψ₄). Consequently at any future time we can now calculate the nozzle's offset from the calibration target as:

Nozzle current X location=Ψ₄−xSensor

In this way the encoder positions of the nozzle can be related to the locations of the calibration target and modules on the machine.

Additional automated calibration is possible. For calibrating the taper position, for example, a tape pocket can be found with a common machine vision algorithm. If the taper has its own encoder, then this data can be linked together. Alternatively the position of a sensor on the taper, such as an optical thru beam sensor that senses the leading edge of a tape pocket, or a feature that corresponds to the sensor's location such as a scribe line on a bracket, can be used to calibrate the taper module and the tape pocket location with the rest of the machine.

Other additional automated calibration is also possible. For example, the y position of a tray in a tray stacker can be determined and measured by the same method described but applied in the orthogonal direction. This y position can be compared to the y position of the nozzles in the images from the traveling-camera. The traveling camera can locate a tray pocket or a device in a tray pocket and use this positional information to place a tray in the correct y location to be serviced by the pick and place nozzle.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An overhead traveling camera inspection system for inspecting the condition of electronic semiconductor devices after being handled by a pick and place and deposited in an output module, and for automatically determining the precise location of an input module and an output module by taking a picture of each, said inspection system comprising:
a) an electronic camera,
b) a lens,
c) a carriage onto which said electronic camera and said lens are mounted,
d) a horizontal linear bearing of sufficient length and connected to said carriage so that said carriage can traverse a sufficient range such that the camera can inspect devices placed in multiple said output destination modules serviced by said pick and place,
e) a linear actuator configured so that energizing the actuator can move said carriage along said linear bearing,
f) a positional encoder to provide feedback as to the location of said carriage.

2. The overhead traveling camera inspection system of claim 2 wherein said system automatically determines the location of said modules by using machine vision algorithms to locate a specific feature on each module and referencing the data from said positional encoder and then using this information to pick or place devices on the machine.

3. The overhead traveling camera inspection system of claim 1 wherein said system also calibrates a pick and place nozzle by determining the location of the nozzle in said camera's field of view while referencing said positional encoder and a second encoder that is mechanically linked to said pick and place

4. An overhead traveling camera inspection system for automatically determining and calibrating the precise location of modules on a machine that are serviced by a pick and place in order to increase the accuracy of picking and placing semiconductor devices, said inspection system comprising:
a) an electronic camera,
b) a lens,
c) a carriage onto which said electronic camera and said lens are mounted,
d) a horizontal linear bearing of sufficient length and connected to said carriage so that said carriage can traverse a sufficient range such that the camera can measure the location of multiple modules serviced by said pick and place, for the purpose of calibrating the module locations on the machine,
e) a linear actuator configured so that energizing the actuator can move said carriage along said linear bearing,
f) a positional encoder to provide feedback as to the location of the carriage.

5. The overhead traveling camera inspection system of claim 4 wherein the nozzle of a pick and place is calibrated by moving it past a stationary sensor while noting the data of a second encoder that is coupled to the nozzle, and where the location of the stationary sensor or an indicator of said sensor's position is measured with said camera, and referencing the nozzle's noted encoder position relative to the sensor or sensor indicator's position so that the location of the modules can be known relative to the nozzle's encoder.

6. The overhead traveling camera inspection system of claim 4 wherein the camera also inspects the condition of electronic semiconductor devices after being handled by a pick and place and deposited in an output module, and where said camera can move to inspect devices deposited into different output modules.

7. The overhead traveling camera inspection system of claim 4 which further comprises a stationary calibration target to calibrate the camera pixel size to mathematically link features found within said camera's field of view with said positional encoder.

8. An overhead traveling camera inspection system for automatically determining and calibrating the precise location of modules on a machine that are serviced by a pick and place in order to increase the accuracy of picking and placing semiconductor devices, said inspection system comprising:
a) an electronic camera,
b) a lens,
c) a carriage onto which said electronic camera and said lens are mounted,
d) a horizontal linear bearing of sufficient length and connected to said carriage so that said carriage can traverse a sufficient range such that the camera can measure the location of multiple modules serviced by said pick and place, for the purpose of calibrating the module locations on the machine,
e) a linear actuator configured so that energizing the actuator can move said carriage along said linear bearing,
f) a positional encoder to provide feedback as to the location of the carriage.
g) a stationary calibration target with features of known dimensions, said target used to calibrate the pixel size of the camera.

9. The overhead traveling camera inspection system of claim 8 wherein the nozzle of a pick and place is calibrated by moving it past a stationary sensor while noting the data of a second encoder that is coupled to the nozzle, and where the location of the stationary sensor or an indicator of said sensor's position is measured with said camera, and referencing the nozzle's noted encoder position relative to the sensor or sensor indicator's position so that the location of the modules can be known relative to the nozzle's encoder.
